(19) United States
(12) Patent Application Publication
(10) Pub. No.: US 2013/0117010 A1
(43) Pub. Date: May 9, 2013

(54) METHOD AND DEVICE FOR FILTERING A TRANSLATION RULE AND GENERATING A TARGET WORD IN HIERARCHICAL-PHASE-BASED STATISTICAL MACHINE TRANSLATION

(71) Applicants: Young Sook Hwang, Seoul (KR); Sang-Bum Kim, Seoul (KR); Chang Hao Yin, Seoul (KR); Zhiyang Wang, Beijing (CN); Qun Liu, Beijing (CN); Yajuan Lv, Beijing (CN)

(72) Inventors: Young Sook Hwang, Seoul (KR); Sang-Bum Kim, Seoul (KR); Chang Hao Yin, Seoul (KR); Zhiyang Wang, Beijing (CN); Qun Liu, Beijing (CN); Yajuan Lv, Beijing (CN)

(73) Assignee: SK PLANET CO., LTD., Seoul (KR)

(21) Appl. No.: 13/809,835

(22) PCT Filed: May 31, 2011
(86) PCT No.: PCT/KR2011/003977

§ 371 Date: Jan. 11, 2013

(30) Foreign Application Priority Data
Jul. 13, 2010 (KR) 10-2010-0067635

(51) Int. Cl. G06F 17/28

(52) U.S. Cl. CPC G06F 17/2881
USPC 704/2

(57) ABSTRACT

Disclosure relates to a statistical machine translation field, and more particularly to a method and a device for filtering a translation rule and generating a target word in a hierarchical phrase-based statistical machine translation. The method and device filters a translation rule using a relaxed-well-formed dependency structure and generates a target word by referring to a head word of a source word in a hierarchical phrase-based statistical machine translation. The disclosure improves a translation performance while reducing a number of translation rules, in comparison with a hierarchical phrase-based original translation rule table.

### TECHNICAL FIELD

The present disclosure relates to a statistical machine translation field, and more particularly to a method and a device that filter translation rules and generate target words in a hierarchical phrase-based statistical machine translation. The present disclosure can improve translation performance while reducing a number of translation rules, in comparison with a hierarchical phrase-based original translation rule table, by filtering the translation rules using a relaxed-well-formed dependency structure and generating the target words by referencing to a head word of a source word in the hierarchical phrase-based statistical machine translation.

### BACKGROUND ART

For the past several decades, a data driving scheme has been very successfully used in a machine translation technology field. Many researches have been conducted on a statistical machine translation (SMT) field to improve operation capability and use a large-scale corpus. A recent method utilizes a hierarchical structure for a translation model.

Descriptions will be made using a hierarchical phrase-based (HPB) model as an example. A hierarchical scheme finds phrases containing several subphrases and replaces a sub-phrase with a non-terminal symbol. Here, the non-terminal symbol is a word which cannot appear in a sentence in view of the grammar, and refers to a word in the normal grammar. The hierarchical scheme is more powerful than a conventional phrase-based scheme because the hierarchical scheme has a good generation capability and allows a long distance reordering. However, when a training corpus becomes larger, the number of translation rules is rapidly increased, and thus a decoding speed becomes slower and the memory consumption for decoding is increased. Accordingly, the hierarchical scheme is not suitable for an actual large-scale translation task.

From the past, considerably many technologies have been proposed to reduce the size of the hierarchical translation rule table. Some developers use a key phrase of a source language side to filter a translation rule table without the use of linguistic information. Some developers add translation rules to a syntactic class based on a number of patterns and non-terminal symbols, and apply several filtering schemes to improve the quality of the translation rule table.

A technology using dependency information removes many translation rules of the translation rule table under the constraints that the translation rule of the target language side should be a well-formed dependency structure, but such a filtering scheme deteriorates the translation performance. To this end, the technology using the conventional dependency information improves the performance by newly adding a dependency language model.

The translation rule is necessary for a statistical machine translation system. In general, as the number of good rules increases, the translation performance is improved. However, as described above, when the training corpus becomes larger, the number of translation rules is rapidly increased, and thus the decoding speed becomes slower and the memory consumption for decoding is increased.

In the SMT field, all translation rules are automatically trained from a corpus. However, not all translation rules are good. As described above, a hierarchical translation rule is obtained by finding a phrase including other phrases and replacing a sub-phrase with non-terminal symbol in the HPB model. The translation rule generation method described above is very simple and many translation rules are linguistically inappropriate, so not all the translation rules are helpful.

Further, in the related art, the target word is generated by introducing a second word without considering the linguistic information. Furthermore, since the second word can appear in any part of the sentence, a huge number of parameters may be required. Another method is to build a maximum entropy model. The maximum entropy model combines abundant context information for selecting the translation rule in the decoding. However, there is a problem in that the maximum entropy model is increased as the corpus becomes large.

### DETAILED DESCRIPTION OF DISCLOSURE

### Problems to be Solved

The present disclosure has been made in an effort to solve the above-mentioned problem, and an object of the present disclosure is to improve a translation performance while reducing the size of the hierarchical translation rule table that depends on the dependency information of the bilingual languages.

Another object of the present disclosure is to further improve the translation performance while not increasing the system complexity caused by the use of an additional language model.

### Technical Solution for the Problems

According to a first aspect of the present disclosure, there is provided a method of filtering a translation rule, in which the number of the hierarchical phrase-based translation rules of a source language side and a target language side are reduced by using a relaxed-well-formed dependency structure.

According to a second aspect of the present disclosure, there is provided a method of generating a translation rule, which includes: aligning words included in a sentence of a source language and a target language; configuring the aligned words in a matrix; grouping words dependent on a common head word in the matrix; and generating the translation rule using the generated phrase.

According to a third aspect of the present disclosure, the method of generating a target word is triggered by not only a corresponding source word but also by a context head word of the source word.

According to a fourth aspect of the present disclosure, there is provided a hierarchical phrase-based statistical machine translation method, which includes: generating a hierarchical phrase-based translation rule using a relaxed-well-formed dependency structure of a source language side and a target language side; and translating a source language text to a target language text by using the generated translation rule and applying a trigger scheme for a head word of a source word.

According to a fifth aspect of the present disclosure, there is provided a device that generates a translation rule, which includes: a word aligner configured to word-align a bilingual corpus including a sentence of a source language and a target language; a word analyzer configured to parse the bilingual corpus to generate a dependency tree according to a relaxed-well-formed dependency structure; and a translation rule extractor configured to generate the translation rule using the word-aligned bilingual corpus and the dependency tree to generate the translation rule.

According to a sixth aspect of the present disclosure, there is provided a decoder that converts a source language text to a target language text using a translation rule generated by a relaxed-well-formed dependency structure from a bilingual corpus and a language model generated from a monolingual corpus.

### ADVANTAGEOUS EFFECTS

The present disclosure has an effect of improving a translation performance in comparison with a conventional HPB translation system while removing unnecessary translation rules by 40% from an original translation rule table by applying a relaxed-well-formed (RWF) dependency structure to both a source language side and a target language side to remove the translation rules which do not satisfy the RWF dependency structure.

Further, the present disclosure has an effect of further improving the translation performance by applying a head word trigger corresponding to a new language characteristic together with the RWF dependency structure. Particularly, the language characteristic according to the present disclosure is effective in Chinese-English translation task, and specifically, effectively acts on a large-scale corpus.

### BRIEF DESCRIPTION OF DRAWINGS

FIG. 1 is a diagram illustrating an example of a dependency tree;

FIG. 2 is a diagram illustrating a relationship between a source word and a target word; and

FIG. 3 is a diagram illustrating a statistical machine translation device according to the present disclosure.

### EMBODIMENTS FOR CARRYING OUT THE PRESENT DISCLOSURE

Hereinafter, exemplary embodiments according to the present disclosure will be described in detail with reference to the accompanying drawings. A configuration of the present disclosure and an operation effect according to the configuration will be clearly understood through the following detailed description.

Prior to the detailed description of the present disclosure, it is to be noted that a detailed description of publicly well-known functions and configurations will be omitted when it may make the subject matter of the present disclosure rather unclear.

According to the present disclosure, the translation rules which do not satisfy a relaxed-well-formed (RWF) dependency structure are removed by applying the RMF dependency structure to both a source language side and a target language side. By using such a method, it is possible to remove unnecessary translation rules by about 40% from an original translation rule table and make the translation performance better than the conventional HPB translation system.

While a conventional well-formed dependency structure is applied to only the target language side, the relaxed-well-formed dependency structure according to the present disclosure is applied to both the source language side and the target language side.

Based on such a relaxed-well-formed dependency structure, the present disclosure also improves the translation performance by introducing new language characteristics. In the conventional phrase-based SMT model, there is a lexical translation probability p (e|f) based on IBM model 1. That is, a target word e is triggered by a source word f.

However, intuitively, the generation of the target word e may not only be involved in the source word f but also triggered by another context word of the source language side. Here, it is assumed that a dependency edge (f→f′) of the word f generates the target word e. This strategy is called a head word trigger.

Accordingly, two words in one language trigger a meaning of one word in another language, which provides a more sophisticated and better choice for the target word. Such dependency relationship characteristics have an effect in Chinese-English translation task, and particularly, effectively act in a large-scale corpus.

As described above, the present disclosure employing the dependency edge as a condition is completely different from a conventional scheme of analyzing context information.

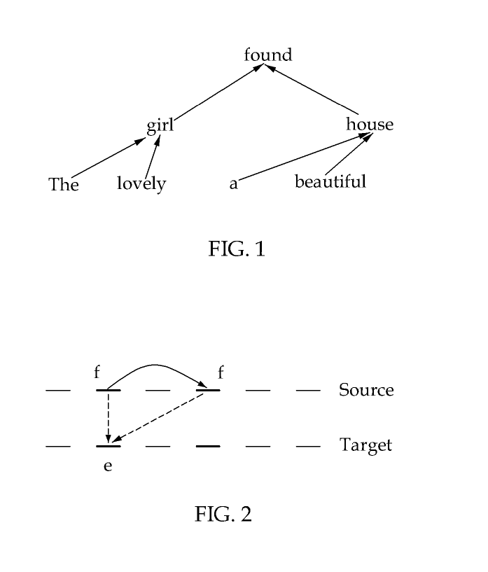

In FIG. 1 illustrating an example of a dependency tree, a word “found” becomes a root of a tree.

Some machine translation developers propose the well-formed dependency structure to filter the hierarchical translation rule table. The well-formed dependency structure may be a single-rooted dependency tree or a set of sibling trees. Since many translation rules are discarded under the constraints that the target language side should be the well-formed dependency structure, the translation performance is deteriorated.

The present disclosure proposes the so called relaxed-well-formed dependency structure expanded from the well-formed dependency structure to filter the hierarchical translation rule table.

It is assumed that there is a sentence S=w_1w_2 . . . w_n. In this case, d_1d_2 . . . d_n indicates a position of a parent word for each word in the sentence S. For example, d_3=4 means that w_3 is dependent on w_4. If w_i is the root, it is defined that d_i=−1.

Formally, a dependency structure w_i . . . w_j is the relaxed-well-formed dependency structure. Here, h∉e [i, j], and all words w_i . . . w_j are directly or indirectly dependent on w_h or −1. Here, h=−1. If the following conditions are satisfied, the relaxed-well-formed dependency structure may include the well-formed dependency structure through its definition.

d_h∉[i,j]

∀k∈[i,j],d_k∈[i,j] or d_k=h

The relaxed-well-formed dependency structure may include a set constituted by a plurality of words, instead of a head word, and the plurality of words may be dependent on a common head word. The head word corresponds to a parent word of each word.

In the relaxed-well-formed dependency structure, all children words of a sub root do not need to be complete. With reference to the dependency tree of FIG. 1, when excluding the well-formed dependency structure, “girl found a beautiful house” may be extracted. Accordingly, when a modifier “the lovely” is changed to “the cute”, this rule works.

TABLE 1

| System | Rule table size |
|---|---|
| HPB | 30,152,090 |
| RWF | 19,610,255 |
| WF | 7,742,031 |

[Table 1] shows the size of the translation rule table when several constraints are applied to the FBIS. The FBIS corpus includes sentence pairs of 239 K having Chinese words of 6.9 M and English words of 839 M.

In [Table 1], the HPB refers to a basic hierarchical phrase-based model, the RWF refers to a model to which the relaxed-well-formed dependency structure is applied, and the WF refers to a model to which the well-formed dependency structure is applied. As shown in [Table 1], the size of the translation rule table becomes smaller in the order of HPB, RWF, and WF.

The RWF filtered out 35% of the original translation rule table, the WF removes 74% of the original translation rule table. The RWF additionally extracts translation rules of 39% in comparison with the WF. Added translation rules are suitable in the sense of linguistics.

Characteristics of the trigger by the head word applied to a log-linear model are based on a trigger-based approach.

The source word f is aligned with the target word e in the conventional phrase-based SMT system, while the lexical translation probability is p(e|f) according to IBM model 1. However, the generation of the target word e is not only triggered by the aligned source word f but also associated with a head word f′ of the word f in an aspect of a dependency relation. Accordingly, the lexical translation probability becomes p(e|f→f′), and enables a more sophisticated lexical choice for the target word.

In FIG. 2 illustrating a relationship between a source word and a target word, a solid line arrow indicates the dependency relation from a child (f) to a parent (f′). The target word e is triggered by the source word f and the head word f′ of the source word f. That is, the lexical translation probability is p(e|f→f′).

Particularly, the translation probability may be calculated by a maximum likelihood (MLE).

$$p ( e \vert f -> {f}^{′} ) = \frac{count ( e , f -> {f}^{′} )}{{\sum }_{{e}^{′}} count ( {e}^{′} , f -> {f}^{′} )}$$

A dependency relation of a phrase pair of f̅ and ē, word alignment a, and a source sentence d₁^{J} (where, J is a length of the source sentence and I is a length of the target sentence) is given.

Accordingly, if a lexical translation probability distribution p(e|f→f′) is given, a characteristic value of the phrase pair of f̅ and ē is calculated as follows.

$$p ( \overline{e} \vert \overline{f} , {d}_{1}^{J} , a ) = {\prod }_{i = 1}^{I} \frac{1}{\vert \{ j \vert ( j , i ) ∈ a ] \vert} {\sum }_{∀ ( j , i ) ∈ a} p ( {e}_{i} \vert {f}_{j} -> {f}_{{d}_{j}} )$$

When p(ē| f̅, d₁^{J}, a) is calculated, p(ē| f̅, d₁^{I}, a) may be calculated in a similar manner.

d₁^{J} denotes a dependency relation of the target language side. Such a new characteristic is added to a log-linear model along with the lexical weighting.

TABLE 2

| System | Dev02 | Test04 | Test05 |
|---|---|---|---|
| HPB | 0.3473 | 0.3386 | 0.3206 |
| RWF | 0.3539 | 0.3485** | 0.3228 |
| RWF + Tri | 0.3540 | 0.3607** | 0.3339* |

[Table 2] shows a result of a GQ corpus. GQ is manually selected from an LDC corpus. GQ includes sentence pairs of 1.5 M having Chinese words of 41 M and English words of 48 M. The FBIS is a subset of GQ.

Here, Tri refers to a characteristic head word trigger in both sides. *or** means better than a basis.

In [Table 2], the translation rules of 152 M are generated from the GQ corpus according to a basic extraction method. If both sides are restricted using an RWF structure, the number of translation rules becomes 87 M indicating that 43% of translation rules are removed from the total translation rules.

A new characteristic works on two difference tests (Test 04 and Test 05) from [Table 2]. Gain is +2.21% BLEU on Test 04, and gain is +1.33% on Test 05. A translation quality is evaluated using a case-insensitive BLEU metric. In the case of using only the RWF structure, the same performance as the basis is shown on Test 05, and a gain of +0.99% is shown on Test 04.

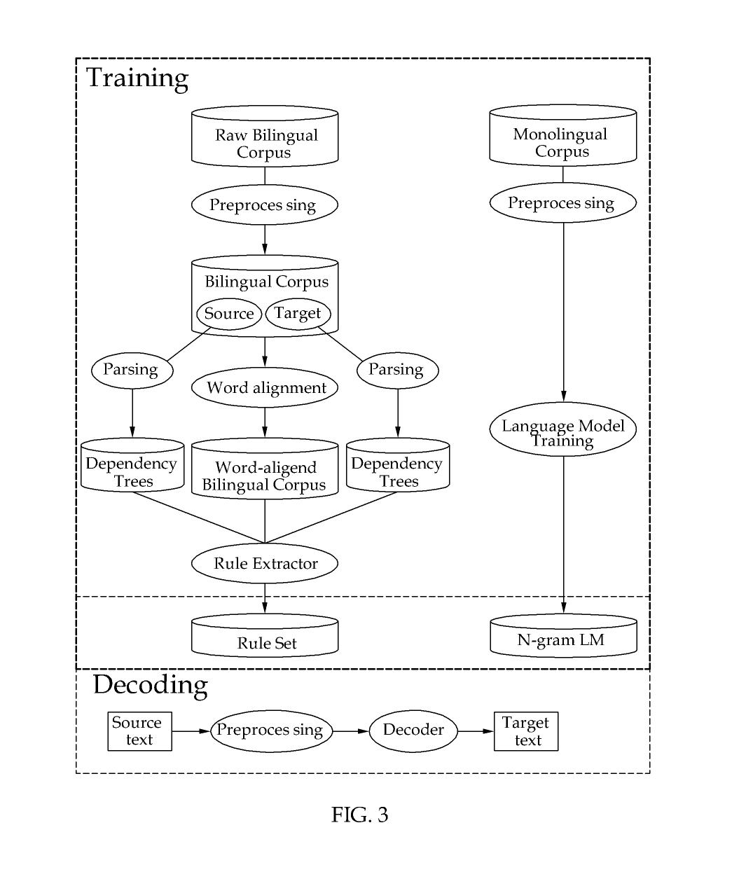

FIG. 3 illustrates an internal configuration of a statistical machine translation device according to the present disclosure. The statistical machine translation device largely includes a training part and a decoding part.

Briefly describing an operation of the training part, the source language and the target language constituting a bilingual corpus are first word-aligned, and each of the source language and the target language is parsed to generate dependency trees. The dependency trees of the source language and the target language are generated by using the relaxed-well-formed dependency structure according to the present disclosure. The word-aligned bilingual corpus and the respective dependency trees are input to a translation rule extractor, and the translation rule extractor generates a translation rule set. The size of the translation rule table generated by the translation rule extractor according to the present disclosure is smaller than that of the translation rule table of the basic HPB system.

A monolingual corpus corresponds to the target language, and an N-gram language model is generated through an N-gram analysis method after a language model training. Here, N-gram refers to N adjacent syllables. For example, in “ [symbol] ”, 2-gram is “ [symbol] ”, “ [symbol] ”, or “ [symbol] ”.

Briefly describing the operation of the decoding part, a source language text is pre-processed and then input to a decoder, and the decoder generates a target language text by using the translation rule set and the N-gram language model. The decoder uses the translation rule table generated by the relaxed-well-formed dependency structure according to the present disclosure and applies the head language trigger to generate the target language text. Therefore, the decoder according to the present disclosure can improve the translation performance.

Meanwhile, the present disclosure implements the method of filtering of the translation rule and generating the target word by a software program, and records the software program in a predetermined computer readable recording medium to be applicable to various reproducing devices. The various reproducing devices may be, for example, a PC, a notebook, and a portable terminal.

For example, the recording medium may be an internal recoding media of each reproducing apparatus, such as for example, a hard disk, a flash memory, a RAM, or a ROM, and may be an external recording medium of each reproducing apparatus, such as for example, optical disk such as a CD-R or a CD-RW, a compact flash card, a smart media, a memory stick, or a multimedia card.

The exemplary embodiments disclosed in the specification of the present invention do not limit the present disclosure. The scope of the present disclosure must be defined according to the appended claims, and all technologies that falls within the equivalent to the claimed inventions must be construed as being included in the scope of the present disclosure.

### INDUSTRIAL APPLICABILITY

The present disclosure applies a relaxed-well-formed dependency structure method to both a source language side and a target language side, and as a result, the size of an original translation rule table is reduced while improving the translation performance as compared to the conventional HPB translation system. Also, the translation performance may be further improved when a head word trigger corresponding to a new language characteristic is applied along with the relaxed-well-formed dependency structure method. Therefore, the present disclosure may be widely used in a hierarchical phrase-based statistical machine translation field.

1. A method of filtering a translation rule characterized by reducing a hierarchical phrase-based translation rule of a source language side and a target language side using a relaxed-well-formed dependency structure.

2. The method of claim 1, wherein the relaxed-well-formed dependency structure is w_i . . . w_j, and satisfies following conditions of:
d_h∉[i,j] (1)
and
∀k∈[i,j],d_k∈E[i,j] or d_k=h (2)

3. The method of claim 1, wherein the relaxed-well-formed dependency structure includes a set constituted by a plurality of words instead of a head word.

4. The method of claim 3, wherein the plurality of words constituting the set are dependent on a common head word.

5. A method of generating a translation rule characterized by comprising:
a step of aligning words included in a sentence of a source language and a target language;
a step of configuring the aligned words in a matrix;
a step of grouping words dependent on a common head word in the matrix to generate a phrase; and
a step of generating the translation rule using the generated phrase.

6. The method of claim 5, wherein a word constituting the generated phrase is not a head word.

7. A method of generating a target word characterized in which a statistical generation of the target word is triggered by not only a corresponding source word but also by a context head word of the source word.

8. The method of claim 7, wherein the target word is triggered by the context head word of the source word and generated under a condition of a dependency edge.

9. The method of claim 7, wherein a trigger by the head word is integrated into a log-linear model.

10. A hierarchical phrase-based statistical machine translation method characterized by comprising:
generating a hierarchical phrase-based translation rule using a relaxed-well-formed dependency structure of a source language side and a target language side; and
translating a source language text to a target language text by using the generated translation rule and applying a trigger scheme for a head word of a source word.

11. The hierarchical phrase-based statistical machine translation method of claim 10, wherein the relaxed-well-formed dependency structure includes a set constituted by a plurality of words instead of the head word, and the plurality of words are dependent on a common head word.

12. An apparatus for generating a translation rule characterized by comprising:
a word aligner configured to word-align a bilingual corpus including a sentence of a source language and a target language;
a word analyzer configured to parse the bilingual corpus to generate a dependency tree according to a relaxed-well-formed dependency structure; and
a translation rule extractor configured to generate the translation rule using the word-aligned bilingual corpus and the dependency tree.

13. A decoder characterized by converting a source language text to a target language text using a translation rule generated by a relaxed-well-formed dependency structure from a bilingual corpus and a language model generated from a monolingual corpus.

14. The decoder of claim 13, wherein a target word constituting the target language text is generated by being triggered by a source word constituting a source language and a head word of the source word.

15. A computer readable recording medium for recording a program for executing the method of claim 1.
